(19) United States
(12) Patent Application Publication
(10) Pub. No.: US 2007/0264874 A1
(43) Pub. Date: Nov. 15, 2007

(54) Fuse structure of a semiconductor device and method of manufacturing the same

(75) Inventor: Jong-Seop Lee, Osan-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/797,825

(22) Filed: May 8, 2007

(30) Foreign Application Priority Data
May 9, 2006 (KR) 10-2006-0041413

(51) Int. Cl. H01R 13/68

(52) U.S. Cl. 439/620.29

(57) ABSTRACT

A fuse structure of a semiconductor memory device may include a substrate including a fuse region, an insulation layer pattern having a multi-layered structure, and/or a plurality of fuse lines. The plurality of fuse lines may pass through an inner space of an opening portion of the insulation layer pattern having the multi-layered structure that exposes the fuse region and may be spaced apart from a surface of the fuse region.

### PRIORITY STATEMENT

This application claims the benefit of priority under 35 USC § 119 to Korean Patent Application No. 10-2006-0041413 filed on May 9, 2006, in the Korean Intellectual Property Office, the contents of which are herein incorporated by reference in their entirety.

### BACKGROUND

1. Field

Example embodiments relate to a fuse structure of a semiconductor device and/or a method of forming the same. For example, example embodiments relate to a fuse structure of a semiconductor device and/or a method of forming the fuse structure in which a defective cell may be repaired by using a lower energy laser beam.

2. Description of Related Art

A semiconductor device may be formed through a fabrication process that forms cells having an integrated circuit by repeatedly forming a setting circuit pattern on a substrate including silicon, and an assembly process that packages the substrate on which the cells are formed as a chip unit. An inspection process, e.g., an electrical die sorting (EDS) process is performed after the FAB process, but prior to the assembly process in order to inspect an electrical property of the cells formed on the substrate.

The inspection process inspects whether the cells formed on the substrate are electrically ‘good’ or ‘defective.’ The ‘defective’ cells are detected through the inspection process in an early stage and regenerated using a repair process.

In the repair process, a wire connected to the ‘defective’ cell is cut by eradiating a laser beam, and the ‘defective’ cell is substituted with a redundancy cell stored in a chip.

In the semiconductor device, a fuse region includes a region in which the fuse lines are arranged and a peripheral region thereof.

For example, the fuse lines are patterned to be parallel with each other on a lower insulation layer, and an upper insulation layer and a protecting layer are formed on the lower insulation layer to fill up the fuse lines. The protecting layer and the upper insulation layer are partially etched to form a fuse opening portion. The fuse opening portion may be formed not to expose the surface of the fuse line or formed to partially expose an upper portion of the fuse line. The fuse line is cut by eradiating the laser beam through the fuse opening portion.

In a case where the fuse lines are built in a complex insulation layer or the lower insulation layer is adhered to the fuse line, a laser beam having a higher energy is required in order to completely cut the fuse lines. Accordingly, if the fuse line is cut by an eradiated laser beam, a defect, for example a crack, may be generated in the lower insulation layer that supports the fuse lines due to an outbreak of an applied excessive energy. The crack may cause damages to other cells adjacent to the fuse lines to be cut, and result in having the damaged adjacent cells substituted with the redundancy cells.

On the other hand, a conductive layer pattern that is conventionally provided as the fuse line includes a barrier layer having a multi-layered structure of titanium and titanium nitride (TiN), and a metal layer provided as a conductive layer. If the laser beam does not have sufficient energy, the barrier layer may not be completely cut and remain on the lower insulation layer. The above-mentioned defect may be caused by an adhesive strength between the barrier layer of the fuse line and the lower insulation layer, and may cause the ‘defective’ cell to not be substituted with the redundancy cell, thereby decreasing a throughput of the semiconductor device.

### SUMMARY

Example embodiments may provide a fuse structure of a semiconductor device that includes a fuse line that may be completely cut using a lower energy, and/or that may have a greater structural stability.

Example embodiments may provide a method of manufacturing the above-mentioned fuse structure.

According to an example embodiment, a fuse structure of a semiconductor device may include a substrate, an insulation layer pattern, and/or a plurality of fuse lines. The substrate may include a fuse region. The insulation layer pattern may have an opening portion that exposes the fuse region. The plurality of fuse lines may be supported by sidewalls of the insulation layer pattern that define the opening portion, and/or the fuse lines may be arranged to horizontally pass through an inner space of the opening portion.

According to an example embodiment, the plurality of fuse lines may be spaced apart from a bottom surface of the opening portion.

According to an example embodiment, a fuse structure of a semiconductor device may include a substrate, an insulation layer pattern, and/or a plurality of fuse lines. The substrate may include a fuse region. The insulation layer pattern may have an opening portion exposing the fuse region of the substrate and/or may have a multi-layered structure. The plurality of fuse lines may pass through an inner space of the opening portion and may be spaced apart from a surface of the fuse region.

According to an example embodiment, the plurality of fuse lines may horizontally pass through the inner space of the opening portion.

According to an example embodiment, reinforcement members may be structurally combined with the fuse lines to improve a structural stability of the fuse lines.

According to an example embodiment, the insulation layer pattern may include an upper insulation layer pattern and a lower insulation layer pattern, and the fuse lines may be interposed between the upper insulation layer pattern and the lower insulation layer pattern.

According to an example embodiment, the reinforcement members may be second insulation layer patterns covering surfaces of the fuse lines exposed by the opening portion, respectively. The second insulation layer patterns may include silicon nitride. A thickness of the second insulation layer patterns may be about 500 \acute{Å} to about 100 \acute{Å}.

According to an example embodiment, the reinforcement members may have one of a fin shape, a cylindrical shape, and a rectangular prism shape. The reinforcement member may include vertical patterns for supporting the fuse lines, and/or lower end portions of the vertical patterns may be buried in the lower insulation layer pattern. The vertical patterns may be arranged along a longitudinal direction of the fuse lines, and/or a longitudinal distance between the vertical patterns may be shorter than a distance between the fuse lines. Each of the fuse lines and the vertical patterns for supporting the fuse lines may be one body.

According to an example embodiment, the reinforcement members may include horizontal patterns connected to the lower end portions of the vertical patterns. The horizontal patterns may be spaced apart from each other. The lower insulation layer pattern may include a first lower insulation layer pattern formed on the substrate, and a second lower insulation layer pattern formed on the first lower insulation layer pattern and having a recess for defining a lower portion of the opening portion. The vertical patterns and the horizontal patterns may include a metal, and/or each of the fuse lines may include an adhesive layer and a metal layer.

According to an example embodiment, in a method of forming a fuse structure of a semiconductor device, an insulation layer including a plurality of fuse lines on a substrate including a fuse region may be formed. An insulation layer pattern having an opening portion that exposes the fuse region may be formed by partially removing the insulation layer to detach the fuse lines from a surface of the fuse region.

According to an example embodiment, in the method reinforcement members that are structurally combined with the fuse lines to enhance a structural stability of the fuse lines may be formed.

According to an example embodiment, forming the reinforcement members may include forming second insulation layer patterns covering surfaces of the fuse lines exposed by the opening portion, respectively.

According to an example embodiment, forming the insulation layer may include forming a lower insulation layer on the substrate, forming a plurality of the fuse lines on the lower insulation layer, and/or forming an upper insulation layer on the lower insulation layer. Forming the insulation layer pattern may include anisotropically etching the upper insulation layer of the fuse region to form a preliminary opening portion exposing a surface of the fuse lines and isotropically etching the lower insulation layer that defines a bottom surface of the preliminary opening portion to form the opening portion to allow the fuse lines to be spaced apart from the surface of the fuse region. An adhesive layer and a metal layer may be successively stacked to form the fuse lines.

According to an example embodiment, forming the reinforcement members may include forming second insulation layer patterns to cover surfaces of the fuse lines exposed through the opening portion, respectively.

According to an example embodiment, the lower insulation layer pattern may include a first lower insulation layer pattern formed on the substrate, and/or a second lower insulation layer pattern formed on the first lower insulation layer pattern. Forming the reinforcement members may include patterning the second lower insulation layer to form a plurality of holes exposing the first lower insulation layer, and filling the holes with vertical patterns on which the fuse lines are formed. The holes may be arranged along a longitudinal direction of the fuse line, and a longitudinal distance between the holes may be shorter than a distance between the fuse lines. Each of the fuse lines and the vertical patterns may be formed in one body.

According to an example embodiment, forming the reinforcement members may further include forming horizontal patterns, which are exposed through the holes, on the first lower insulation layer.

According to an example embodiment, the vertical patterns may be formed simultaneously during forming a contact plug of the semiconductor device, the horizontal pattern may be formed simultaneously during forming a conductive wiring of the semiconductor device, and/or the fuse lines may be formed simultaneously during forming the conductive wiring of the semiconductor device.

According to an example embodiment, the fuse line may be more easily cut by a laser beam having a lower energy during a repair process by removing the insulation layer supporting the fuse lines or covering the surface of the fuse lines in the fuse region.

### BRIEF DESCRIPTION OF THE DRAWINGS

The above and/or other aspects and advantages will become more apparent and more readily appreciated from the following detailed description of example embodiments taken in conjunction with the accompanying drawings of which:

FIG. 1 is a cross-sectional view illustrating a fuse structure of a semiconductor device according to an example embodiment;

FIG. 2 is a plan view illustrating the fuse structure in FIG. 1;

FIGS. 3 and 4 are cross-sectional views illustrating a method of manufacturing the fuse structure of the semiconductor device in FIG. 1;

FIG. 5 is a cross-sectional view illustrating a fuse structure of a semiconductor device having an improved structural stability according to another example embodiment;

FIG. 6 is a plan view illustrating the fuse structure shown in FIG. 5;

FIG. 7 is a cross-sectional view illustrating a fuse structure of a semiconductor device having an improved structural stability according to another example embodiment;

FIG. 8 is a plan view illustrating the fuse structure shown in FIG. 7; and

FIGS. 9 to 11 are cross-sectional views illustrating a method of manufacturing the fuse structure of the semiconductor device in FIG. 7.

### DETAILED DESCRIPTION OF EXAMPLE EMBODIMENTS

Example embodiments will now be described more fully hereinafter with reference to the accompanying drawings. Embodiments may, however, be embodied in many different forms and should not be construed as being limited to the embodiments set forth herein. Rather, these example embodiments are provided so that this disclosure will be thorough and complete, and will fully convey the scope to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of example embodiments (and intermediate structures) of the example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference will now be made to example embodiments, which are illustrated in the accompanying drawings, wherein like reference numerals refer to the like components throughout.

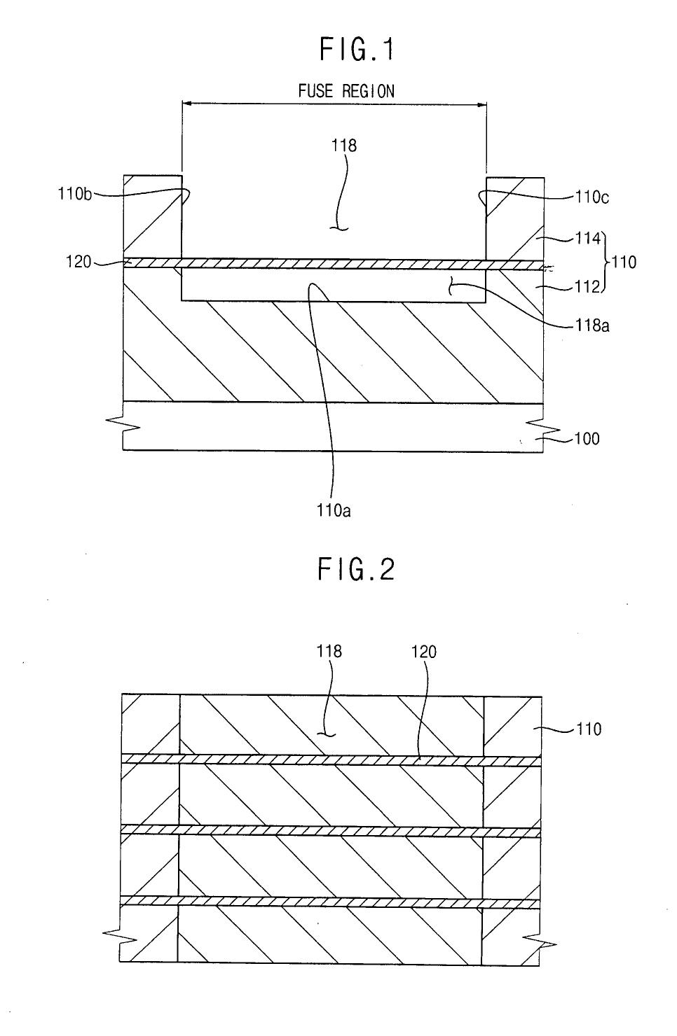

FIG. 1 is a cross-sectional view illustrating a fuse structure of a semiconductor device in accordance with an example embodiment. FIG. 2 is a plan view illustrating the fuse structure in FIG. 1.

Referring to FIGS. 1 and 2, a fuse structure in accordance with an example embodiment may include an insulation layer pattern 110 and a plurality of fuse lines 120. The insulation layer pattern 110 may be formed on a substrate 100, for example a semiconductor substrate, having a fuse region, for example a silicon substrate. The insulation layer pattern 110 may have an opening portion 118 exposing the fuse region. The fuse lines 120 may pass through an inner space of the opening portion 118, for example the fuse lines 120 may horizontally pass through an inner space of the opening portion 118. Further, the fuse lines 120 may be spaced apart from a surface of the fuse region.

In a repair process for substituting a redundancy cell for a defective cell, the opening portion 118 is provided to define the fuse region where a cutting member may be guided to cut the fuse line 120. For example, the defective cell may be sorted out if cells of a semiconductor device are inspected.

The insulation layer pattern 110 having the opening portion 118 may have a multi-layered structure. The insulation layer pattern 110 may include a lower insulation layer pattern 112 having a recess 118a that defines a lower portion of the opening portion 118, and an upper insulation pattern 114 that defines an upper portion of the opening portion 118. The insulting layer pattern 110 may include oxide of a silicon oxide series, for example a high density plasma chemical vapor deposition (HDP-CVD) oxide, tetraethyl orthosilicate (TEOS), undoped silicate glass (USG), phosphorous silicate glass (PSG), boro-phospho-silicate glass (BPSG), spin on glass (SOG), etc., or nitride, for example silicon nitride.

The fuse lines 120 may pass through the inner space of the opening portion 118. A middle portion of each of the fuse lines 120 may be exposed in the fuse region by the opening portion 118, and both end portions of the fuse lines 120 may be fixed to sidewalls 110b and 110c of the insulation layer pattern 110 that defines the opening portion 118. The fuse lines 120 may be spaced apart from a bottom surface 110a of the opening portion 118, e.g., the surface of the fuse region.

The fuse lines 120 may include a conductive material, for example aluminum (Al), copper (Cu), tungsten (W), etc. Each of the fuse lines 120 may have a multi-layered structure including an adhesive layer (or a barrier layer), for example a titanium/titanium nitride (Ti/TiN) layer, and a metal layer successively stacked. The fuse lines 120 may be formed by a process substantially the same as that for forming a metal wiring (not shown) of the semiconductor device.

As mentioned above, the recess 118a may be formed between the fuse lines 120 and the bottom surface 110a of the opening portion 118. Accordingly, because the fuse lines 120 may be spaced apart from the lower insulation layer pattern 112 in the fuse region, the fuse line 120 may be cut by a laser beam having lower energy.

For example, the aforementioned fuse structure of an example embodiment does not have an obstacle in a path of the laser beam, which is generally used for cutting the fuse line 120. The lower insulation layer pattern 112 for absorbing energy in an eradiated laser beam in the fuse region may be spaced apart from the fuse lines 120. If the lower insulation layer pattern 112 makes contact with a lower portion of the fuse lines 120, the lower insulation layer pattern 112 may function as a medium for transmitting the energy of the laser beam to a periphery. In a conventional fuse structure, the energy of the laser beam may be transmitted to the periphery through the lower insulation layer pattern 112, to thereby cause a crack in adjacent fuse lines. However, the aforementioned fuse structure of an example embodiment may reduce an amount of energy required from the eradiated laser beam in order to cut the fuse line 120, thereby decreasing a possibility of defects to the lower insulation layer pattern 112 or adjacent fuse lines.

The fuse line 120 and the lower insulation layer pattern 112 of the fuse structure may not be adhered to each other by an adhesive layer of the fuse line 120. Therefore, if a lower amount of energy is provided from the laser, there may not be any defects generated while cutting the fuse line 120.

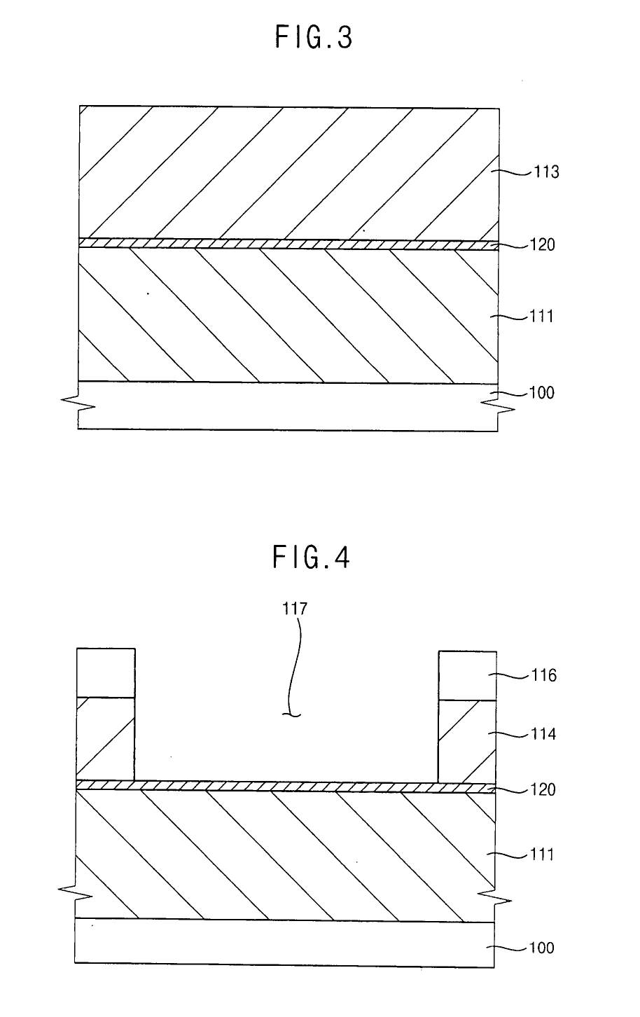

FIGS. 3 and 4 are cross-sectional views illustrating a method of manufacturing the fuse structure of the semiconductor device in FIG. 1.

Referring to FIG. 3, a lower insulation layer 111 having an even upper surface may be formed on the substrate 100 that may include a semiconductor material, for example silicon. The lower insulation layer 111 may include oxide of a silicon oxide series, for example a high density plasma chemical vapor deposition (HDP-CVD) oxide, tetraethyl orthosilicate (TEOS), undoped silicate glass (USG), phosphorous silicate glass (PSG), boro-phospho-silicate glass (BPSG), spin on glass (SOG), etc., or nitride, for example silicon nitride.

A plurality of the fuse lines 120 having a linear shape may be formed on the lower insulation layer 111. The fuse lines 120 may be arranged in parallel with each other having substantially uniform intervals therebetween. For example, the fuse lines 120 may include a metal, for example aluminum (Al), copper (Cu), tungsten, etc. The fuse lines 120 may be formed by repeatedly performing patterning processes, for example a physical vapor deposition process and an anisotropic etching process.

The fuse lines 120 may be formed by successively stacking the adhesive layer (or barrier layer), the metal layer, etc. For example, the adhesive layer may include a titanium/titanium nitride (Ti/TiN) layer, and the metal layer may include aluminum and/or copper. The fuse line 120 may be formed while forming a metal wiring (not shown) of the semiconductor device.

An upper insulation layer 113 may be formed on the lower insulation layer 111 on which the fuse lines 120 are formed. The upper insulation layer 111 may include oxide of a silicon oxide series, for example a high density plasma chemical vapor deposition (HDP-CVD) oxide, tetraethyl orthosilicate (TEOS), undoped silicate glass (USG), phosphorous silicate glass (PSG), boro-phospho-silicate glass (BPSG), spin on glass (SOG), etc., or nitride, for example silicon nitride. The upper insulation layer 113 may have a single-layered structure or a multi-layer structure. For example, a first upper insulation layer including a silicon oxide layer may be formed using a high-density plasma chemical vapor deposition process. A silicon nitride layer may be formed on the first upper insulation layer to form a second upper insulation layer. The second upper insulation layer may be a protection layer corresponding to an uppermost layer of the semiconductor device. The plurality of the fuse lines 120 may be interposed between the lower insulation layer 111 and the upper insulting layer 113.

Referring to FIG. 4, a first photoresist pattern 116 may be formed on the upper insulation layer 113 to define the fuse region. The first photoresist pattern 116 may be formed to expose the upper insulation layer 113 in the fuse region. The upper insulation layer 113 may be anisotropically etched using the first photoresist pattern 116 as an etch mask to expose the fuse lines 120. The upper insulation layer 113 may be changed into an upper insulation layer pattern 114 having a preliminary opening portion 117 that may expose a surface of the fuse lines 120, for example an upper surface of the fuse lines 120. For example, the upper insulation layer pattern 114 may be formed by a reactive ion etching process. The reactive ion etching process may be automatically concluded using an end point detecting method if the surface of the fuse lines 120 is exposed.

Referring again to FIGS. 1 and 2, the lower insulation layer 111 may be isotropically etched to form the opening portion 118. The opening portion 118 may completely expose the fuse lines 120, for example the opening portion 118 may expose the fuse lines 120 from the portion of the lower insulating layer 11 not removed by the formation of the preliminary opening portion 117. The lower insulation layer 111 may be changed into the lower insulation layer pattern 112 having the recess 118a that defines the lower portion of the opening portion 118. For example, the opening portion 118 may be formed by a chemical dry etching process. The isotropic etching process may be performed until the recess 118a is formed under the fuse lines 120.

Because a line width of the fuse line 120 may be minute, the lower insulation layer 111 making contact with the lower surface of the fuse lines 120 may be easily removed from the fuse lines 120. In order to reduce damage of the substrate 100 during a laser repair process, the recess 118a between the fuse lines 120 and the lower insulation layer pattern 112 may be formed not to expose the substrate 100. Although not shown in the attached figures, a width of the opening portion 118 may be extensible.

Alternatively, the insulation layer pattern 110 may be formed by a combined process of a dry etching process and a wet etching process based on the property and structure of the lower and upper insulation layers 111 and 113.

The first photoresist pattern 116 may be removed by an ashing and stripping processes. Accordingly, the upper portion of the fuse line 120 may be exposed through the opening portion 118, and the recess space 118a may be formed between the fuse lines 120 and the opening portion 118 to complete the fuse structure having the fuse lines 120 in FIG. 1. The fuse lines 120 may be completely cut by a laser beam having a lower energy.

Hereinafter, a fuse structure of a semiconductor device including a reinforcement member for improving a structural stability of the fuse line and a method of forming the fuse structure will be explained in detail.

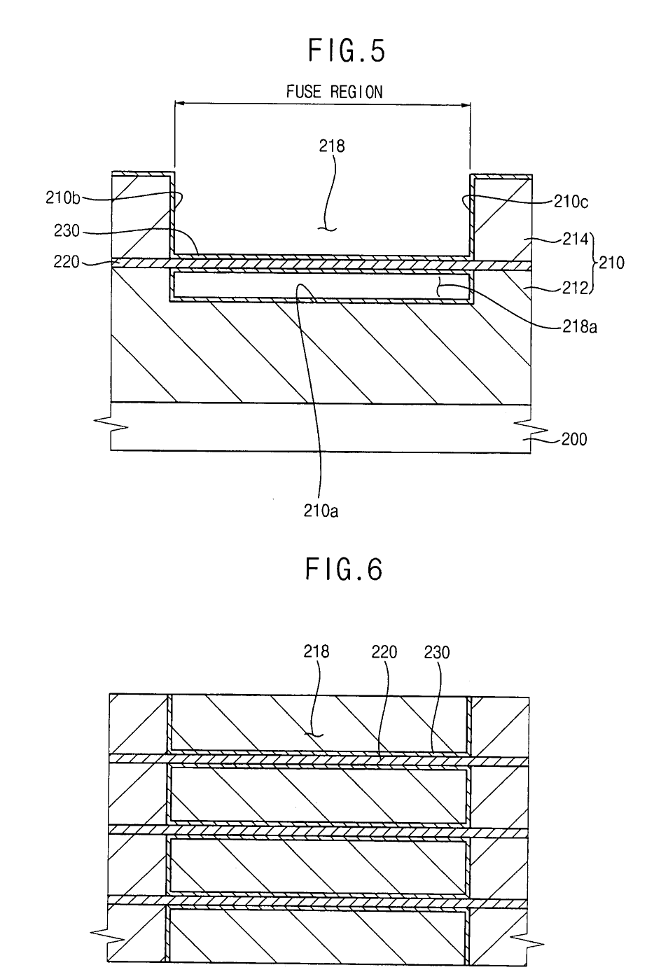

FIG. 5 is a cross-sectional view illustrating a fuse structure of a semiconductor device having an improved structural stability according to another example embodiment. FIG. 6 is a plan view illustrating the fuse structure shown in FIG. 5.

Referring to FIGS. 5 and 6, a fuse structure according to another example embodiment may include an insulation layer pattern 210 having an opening portion 218 that exposes the fuse region on the substrate 200. A plurality of fuse lines 220, which may horizontally passes through an inner space of the opening portion 218 and/or may be spaced apart from a bottom surface of the fuse region, may be arranged in the insulation layer pattern 210.

Descriptions of the elements of FIGS. 5 and 6 are explained below, with particular attention given to the elements of FIGS. 5 and 6 which differ from the elements of FIGS. 1 and 2. Unless specifically noted, the description of those elements in FIGS. 5 and 6 common to the semiconductor device of FIGS. 1 and 2 are the same as described with respect to FIGS. 1 and 2; and may not be described in detail below for the sake of brevity.

Second insulation layer patterns 230 may be formed on an outer surface of the fuse lines 220 to encompass the fuse lines 220. The second insulation layer patterns 230 may be reinforcement members for improving a structural stability of the fuse lines 220. For example, the second insulation layer patterns 230 may be successively formed on surfaces of the insulation layer patterns 210 and the outer surfaces of the fuse lines 220. Accordingly, if the fuse line 220 is cut by a cutting member, for example a laser beam, the reinforcement member may effectively reduce electrical contacts, for example a short between the fuse lines 220, from being generated by scattering and bending of the cut fuse line 220.

For example, the second insulation layer pattern 230 may include a silicon nitride layer. If the second insulation layer pattern 230 has a thickness of less than 500 \acute{Å}, the second insulation layer pattern 230 may not be effective in reducing the electrical contacts from being generated. In contrast, if the second insulation layer pattern 230 has a thickness of more than 1,000 \acute{Å}, an amount of the energy required in the laser beam for cutting the fuse line 220 may be largely increased. Therefore, the second insulation layer pattern 230 may preferably have a thickness of about 500 \acute{Å} to about 1,000 \acute{Å}.

Hereinafter, a method of forming the fuse structure of the semiconductor device in FIG. 5 will be explained in detail.

Referring again to FIGS. 5 and 6, a multi-layered structural insulation layer (not shown) including a plurality of the fuse lines 220 horizontally interposed may be formed on the substrate 200 having the fuse region. The multi-layered structural insulation layer may include a lower insulation layer (not shown) formed under the fuse lines 220, and an upper insulation layer (not shown) formed on the fuse lines 220. The multi-layered structural insulation layer may be partially removed to detach the fuse lines from the surface of the fuse region, thereby forming the opening portion 218 exposing the fuse region. Accordingly, the multi-layered structural insulation layer may be changed into the insulation layer pattern 210 having the opening portion 218.

Descriptions of the method of forming the elements of FIGS. 5 and 6 may be substantially the same as those explained with reference to FIGS. 1-4. Unless specifically noted, the description of the method of forming those elements in FIGS. 5 and 6 common to the semiconductor device of FIGS. 1 and 2 are the same as described with respect to FIGS. 1 and 2; and may not be described in detail below for the sake of brevity.

Referring to FIGS. 5 and 6, the second insulation layer patterns 230 encompassing the surface of each of the fuse lines 230 may be formed. For example, the second insulation layer patterns 230 may be formed on the surface of the exposed fuse structure. The second insulation layer patterns 230 may include nitride, for example silicon nitride (SiN), and may be formed by a chemical vapor deposition process. The second insulation layer patterns 230 may be formed to have a thickness of about 500 \acute{Å} to about 1,000 \acute{Å}. Accordingly, the second insulation layer patterns 230 used for the reinforcement member may reduce the occurrence of shorts between the fuse lines 230 if the fuse lines 230 are cut.

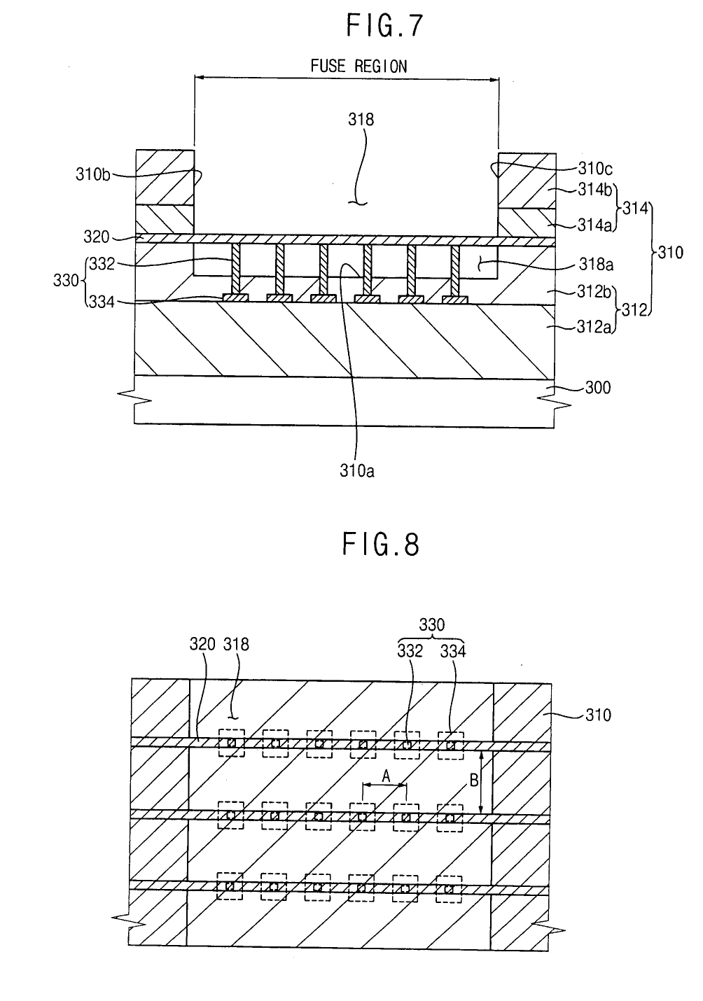

FIG. 7 is a cross-sectional view illustrating a fuse structure of a semiconductor device having an improved structural stability according to another example embodiment. FIG. 8 is a plan view illustrating the fuse structure shown in FIG. 7.

Referring to FIGS. 7 and 8, a fuse structure of a semiconductor device according to another example embodiment may include an insulation layer pattern 310 having an opening portion 318 exposing the fuse region on the substrate 300 on which the fuse region is formed, a plurality of fuse lines 320 passing through an inner space of the opening portion 318, and/or a reinforcement member 330 connected to the fuse lines 320 to improve a structural stability of the fuse lines 320.

The insulation layer pattern 310 having the opening portion 318 may be formed on the substrate 300 including a semiconductor material, for example silicon. In order to substitute the redundancy cell for the defective cell, which may be sorted out after inspecting cells formed on a cell region (not shown), the opening portion 318 may be provided to expose the fuse region where the fuse line 320 connected to the defective cell is cut. Accordingly, the opening portion 318 may have sufficient space where a cutting member, for example a laser beam, for cutting the fuse line 320 may be guided. The insulation layer pattern 310 may include oxide of silicon oxide series for example a high density plasma chemical vapor deposition (HDP-CVD) oxide, tetraethyl orthosilicate (TEOS), undoped silicate glass (USG), phosphorous silicate glass (PSG), boro-phospho-silicate glass (BPSG), spin on glass (SOG), etc., or nitride, for example silicon nitride.

The insulation layer pattern 310 may include a lower insulation layer pattern 312 formed under the fuse lines 320 and an upper insulation layer pattern 314 formed on the fuse lines 320. The lower insulation layer pattern 312 may include a first lower insulation layer pattern 312a formed on the substrate 300 and a second lower insulation layer pattern 312b having a recess 318a that defines a lower portion of the opening portion 318.

The upper insulation layer pattern 314, which may be placed adjacent to the fuse region to define an upper portion of the opening portion 318, may include a first upper insulation layer pattern 314a formed on the second lower insulation layer pattern 312b, and a second upper insulation layer pattern 314b as a protection layer formed on the first upper insulation layer pattern 314a. For example, the first upper insulation layer pattern 314a may include a silicon oxide layer that is formed by a high-density plasma chemical vapor deposition process, and the second upper insulation layer pattern 314b may include a silicon nitride layer that is formed by a plasma enhanced chemical vapor deposition process.

The plurality of the fuse lines 320 may be arranged in the insulation layer pattern 310 and pass through the inner space of the opening portion 318. The fuse lines 320 may be spaced apart from a bottom surface 310a of the opening portion 318 and/or may be fixed to sidewalls 310b and 310c of the insulation layer pattern 310 on the peripheral region of the fuse region. For example, the fuse lines 320 in the fuse region may be completely exposed through the opening portion 318. Accordingly, the upper portion of the fuse lines 320 may be exposed to the atmosphere and a recess 318a may be formed between the fuse lines 320 and the second lower insulation layer pattern 312b so that the fuse lines 320 may be easily cut.

The fuse lines 320 are arranged in parallel with the substrate 300 and spaced apart by a desired, or alternatively, a predetermined distance. The fuse lines 320 may include a conductive material, for example aluminum (Al), copper (Cu), tungsten (W), etc. Each of the fuse lines 320 may have a double-layered structure including an adhesive layer (or barrier layer), for example a titanium/titanium nitride (Ti/TiN) layer, and a metal layer successively stacked or a triple-layered structure including a first adhesive layer, a metal layer, and a second adhesive layer.

The reinforcement member 330 may be formed under the fuse lines 320. The reinforcement member 330 may be combined with the fuse lines 320. The reinforcement member 330 may be provided to improve the structural stability of the fuse lines 320 in the fuse region. For example, the reinforcement member 330 may have a fin, rectangular prism, or cylindrical shape. The reinforcement member 330 may include vertical patterns 332 for supporting the fuse lines 320 and horizontal patterns 334 connected to lower end portions of the vertical patterns 332.

The vertical patterns 332 may be arranged along a longitudinal direction of the fuse lines 320 and/or may be structurally combined with the fuse lines 320. For example, each of the vertical patterns 332 may be arranged under the fuse lines 320 to support the fuse lines 320. The upper portion of the vertical pattern 332 may be exposed by the opening portion 318. The recess 318a may be formed under the fuse lines 320.

The lower portion of the vertical pattern 332 may be buried in the insulation layer pattern 310 corresponding to the bottom surface of the opening portion 318. In a repair process to substitute the redundancy cell for the defective cell, the remaining portion of the fuse line 320 that is cut off after eradiating the laser beam may be supported by the vertical patterns 332, thereby reducing the occurrence of the remaining fuse lines 320 making electrical contact with the adjacent fuse lines.

A distance between the vertical patterns 332 arranged along the longitudinal direction of the fuse lines 320 may be increased in proportion to that of the fixed portion of the fuse lines 320. Accordingly, the distance between the vertical patterns 332 may affect a defect generation rate. For example, a distance A between the vertical patterns 332 may be smaller than a distance B between the fuse lines 320. If the fuse line 320 is bent toward the adjacent fuse line by an energy generated while cutting the fuse line 320 using the laser beam, the distance of the bent fuse lines 320 may be designated as the distance A of the fuse line, which is not fixed by the vertical patterns 332. Because the bent fuse line 320 may be shorter than the distance B between the fuse lines 320, the bent fuse line 320 may not make contact with the adjacent fuse line, thereby lowering a probability of the electrical contact being generated between the adjacent fuse lines 320.

The vertical pattern 332 may include a metal, for example aluminum (Al), copper (Cu), tungsten (W), etc. If the vertical pattern 332 and the fuse line 320 include different materials from each other, the vertical pattern 332 may be connected to the fuse line using the adhesive layer, for example a titanium/titanium nitride (Ti/TiN) layer. However, the vertical pattern 332 may be formed in one body with the fuse line 320 or may include a nonmetallic material combined with the fuse line 320 to fix the fuse line 320.

The horizontal patterns 334 may be formed on the first lower insulation layer 312a, and each of the horizontal patterns 334 may be combined with each of the lower end portions of the vertical patterns 332, respectively. The horizontal patterns 334 may be spaced apart from each other and may have an isolated shape. The horizontal patterns 334 may have a width larger than that of the vertical pattern 332 to firmly support the vertical pattern 332. For example, the horizontal patterns 334 may have a quadrangle or a circular shape. The horizontal patterns 334 may include a metal, for example aluminum (Al), copper (Cu), tungsten (W), etc. However, the horizontal patterns may be omitted to simplify the fuse structure. For example, the vertical pattern may be formed on the first lower insulation layer 312a without the horizontal patterns 334.

In the above-mentioned fuse structure of FIGS. 7 and 8, the fuse lines 320 may be supported by the reinforcement member 330 so that the fuse line 320 does not make contact with the adjacent fuse lines if the fuse line 320 is cut.

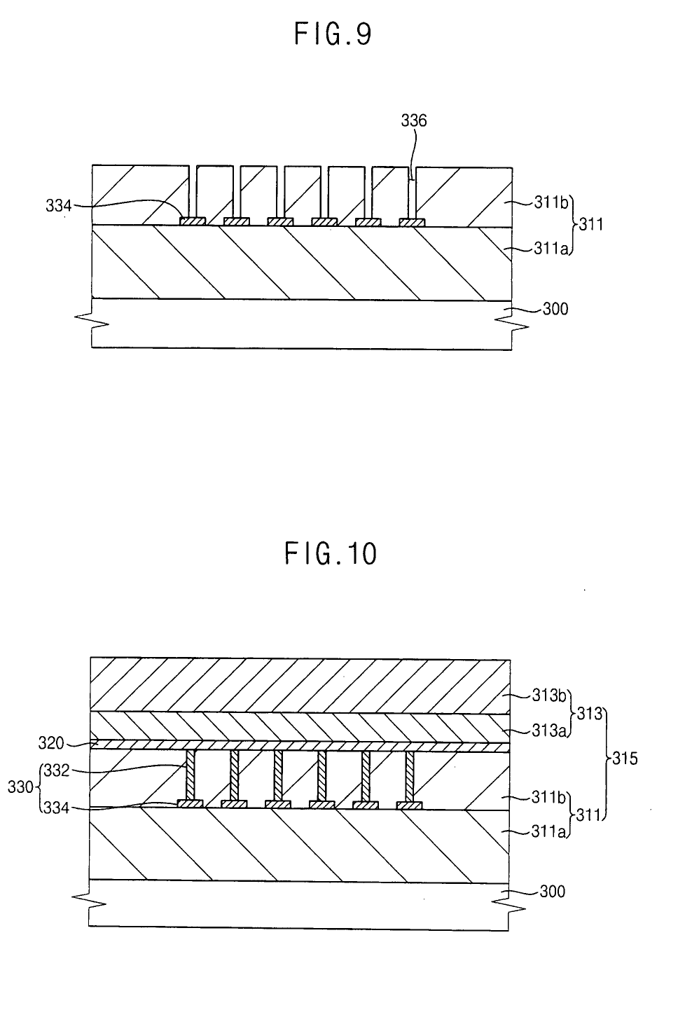

FIGS. 9 to 11 are cross-sectional views illustrating a method of manufacturing the fuse structure of the semiconductor device in FIG. 7.

Referring to FIG. 9, a first lower insulation layer 311a may be formed on the substrate 300 including a fuse region. The horizontal patterns 334 having a desired, or alternatively, a predetermined width may be formed on the first lower insulation layer 311a. The horizontal patterns 334 may have an isolated shape, for example a pad having a circular or quadrangle shape. The adjacent horizontal patterns 334 may be formed to be spaced apart from each other.

The horizontal patterns 334 may be formed simultaneously during forming the metal wiring (not shown) of the semiconductor device. Therefore, an additional process of forming the horizontal pattern 334 may not be necessary. For example, a metal layer (not shown), which forms a bit line (not shown) of the semiconductor device, may be formed to be extended to the first lower insulation layer 311a of the fuse region.

The metal layer according to the fuse region may be patterned to form the horizontal patterns 334 simultaneously during forming the bit line by modifying the mask pattern that is used as an etch mask if the metal layer is patterned to form the bit line.

A second lower insulation layer 311b having holes 336 through which surfaces of the horizontal patterns 334 are exposed may be formed on the first lower insulation layer 311a. For example, after an insulation material and a second photoresist pattern (not shown) are deposited on the first lower insulation layer 311a, the holes 336 may be formed by an anisotropic dry etching process. The first lower insulation layer 311a and the second lower insulation layer 311b may form a lower insulation layer 311 having a multi-layered structure. The holes 336 may be arranged in a longitudinal direction of the fuse lines which may be formed by another process, and overlap the fuse lines. The width or diameter of the holes 336 may be smaller than that of the fuse lines.

However, the process of forming the horizontal pattern 334 may be omitted in order to simplify a process for manufacturing of the fuse structure. For example, an etching process of forming the holes 336 may be performed until the first lower insulation layer 311a is exposed.

Referring to FIG. 10, a vertical pattern 332 may be formed to sufficiently fill up the holes 336. The vertical pattern 332 may include a metal, for example aluminum (Al), copper (Cu), and tungsten (W).

However, the vertical patterns 332 may be formed simultaneously during forming a contact plug on the cell region (not shown) or the peripheral circuit region (not shown) of the semiconductor device. For example, the holes 336 may be formed during the formation of via holes for connecting the bit line and the metal wire formed on the bit line, and the vertical patterns 332 may be formed during formation of the contact plug (not shown) formed in the contact hole or the via hole of the semiconductor device. Because the horizontal pattern 334 and the vertical pattern 332 are formed by a process substantially the same as that for forming the bit line and the contact plug connected thereto, an additional process may not be necessary.

The horizontal pattern 334 and the vertical pattern 332 may be combined with a junction force substantially the same as that between the bit line and the contact plug.

The fuse lines 320, which are connected to the vertical patterns 332, may be formed on the second lower insulation layer 311b having the vertical patterns 332. The adhesive layer, for example a titanium/titanium nitride (Ti/TiN) layer, and a metal layer, for example aluminum (Al), copper (Cu) and/or tungsten (W), may be successively stacked, and/or the adhesive layer and the metal layer may be patterned to have a line shape, so that the fuse lines 320 may be formed. The fuse lines 320 may be combined with the vertical patterns 332 by the adhesive layer. Accordingly, a reinforcement member 330 including the vertical patterns 332 and the horizontal patterns 334 may be completed. However, the reinforcement member 330 may be formed of only the vertical patterns 332 without the horizontal patterns 334.

However, a conductive layer (not shown) sufficiently filling up the holes 336 may be formed on the second lower insulation layer 311b, and the conductive layer on the second lower insulation layer 311b may be patterned to form the fuse lines 320. Accordingly, the vertical pattern 332 and the fuse lines 320 may be formed by an in situ process. For example, the vertical pattern 332 and the fuse lines 320 may be formed as one body,

An upper insulation layer 313 may be formed on the second lower insulation layer 311b on which the fuse lines 320 are formed. The upper insulation layer 313 may have a multi-layered structure including a first upper insulation layer 313a that covers the fuse lines 320 and a second upper insulation layer 313b that may be provided as a protection layer. The first upper insulation layer 313a may include a silicon oxide layer that is formed by a high-density plasma chemical vapor deposition process, and/or the second upper insulation layer 313b may include a silicon nitride layer that is formed by a plasma enhanced chemical vapor deposition process. Accordingly, the fuse lines 320 and the reinforcement members 330 may be arranged in the fuse region of the substrate 300, and an insulation layer 315 including the lower insulation layer 311 and the upper insulation layer 313 may be formed therein.

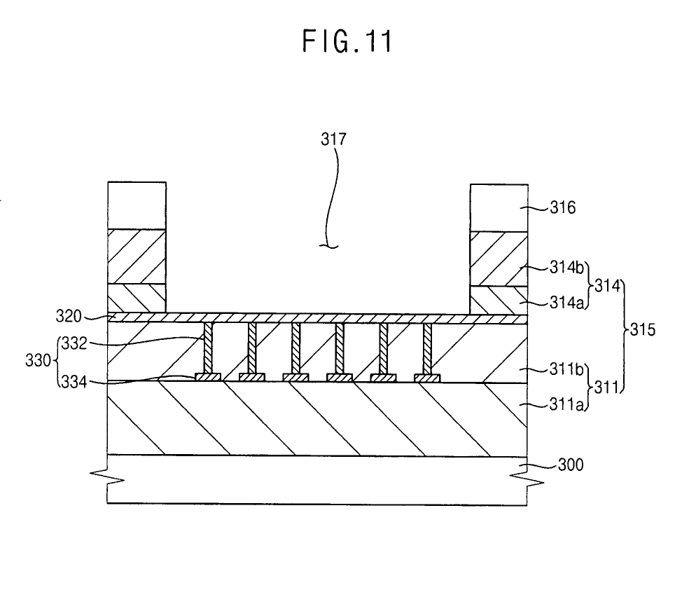

Referring to FIG. 11, a third photoresist pattern 316 may be formed on the upper insulation layer 313 to expose a surface of the upper insulation layer of the fuse region. The upper insulation layer 313 may be anisotropically etched using the third photoresist pattern as an etch mask to expose an upper surface of the fuse lines 320. Accordingly, the upper insulation layer 313 may be changed into an upper insulation layer pattern 314 that has a preliminary opening portion 317 through which the fuse lines 320 are exposed. For example, the upper insulation layer pattern 314 may be formed by a reactive ion etching process. If the surfaces of the fuse lines 320 are exposed and a material in the fuse lines is detected by a sensor, the reactive ion etching process may be completed. Accordingly, the upper insulation layer pattern 314 including the first upper insulation layer pattern 314a and the second insulation layer pattern 314b may be formed.

Referring again to FIGS. 7 and 8, the lower insulation layer 311 that defines the bottom surface of the preliminary opening portion 317 may be isotropically etched to form the opening portion 318, which completely exposes each of the surfaces of the fuse lines 320 arranged on the fuse region, except the portion of the fuse lines 320 contacting the vertical members 332. The lower insulation layer 311 may be etched to form the lower insulation layer pattern 312 that defines the lower portion of the opening portion 318. For example, the opening portion 318 may be extended downward from the fuse lines 320 to expose only the upper portions of the vertical patterns 332. Accordingly, lower portions of the vertical patterns 332 may be buried in the lower insulation layer pattern 312. For example, the opening portion 318 may be formed by a chemical dry etching process, and an etching time, an etchant flux, etc may be controlled not to expose the horizontal patterns 334. Therefore, a recess 318a may be formed below the fuse lines 320 to completely expose the fuse lines 320 in the fuse region.

However, the second lower insulation layer 311b may have a double-layered structure having a lower layer (not shown) and an upper layer (not shown) both of which have a different etch selectivity, respectively. The upper layer may be formed to have a thickness fit for a height of the recess space 318a that is formed under the fuse lines 320. Further, the upper layer may be removed using an etchant having an etch selectivity with respect to the lower layer of the second lower insulation layer 311b by the isotropic etching process.

In another example embodiment, the insulation layer pattern 310 having the opening portion 318 may be formed by only the isotropic etching process or by the isotropic dry etching and wet etching processes.

Therefore, the lower and the upper insulation layers 311 and 313 may be changed into the insulation layer pattern 310 including the lower and the upper insulation layer patterns 312 and 314 that define the opening portion 318 for exposing the fuse region.

If the reinforcement members 330 include the horizontal patterns 334, because the horizontal patterns 334 are supported by the first lower insulation layer 312a, not only the vertical patterns 332 but also the horizontal patterns 334 may be exposed by the opening portion 318.

Accordingly, because the fuse lines 320 are spaced apart from the lower insulation layer pattern 312, the fuse lines 320 may be easily cut by the laser beam having a lower energy, and damage to the adjacent fuse line 320 by an energy transition of the laser beam may be reduced. Because the reinforcement member 330 may be combined with the fuse line 320, the fuse line 320 may be structurally more secured, thereby reducing the probability of the severed fuse line 320 making contact with the adjacent fuse lines 320 if severed by the laser beam.

As mentioned above, in a repair process, each of the fuse lines may be more easily cut by the laser beam having a lower energy, and damages to the severed fuse line and the adjacent fuse line may be reduced, to thereby improve a reliability of the semiconductor device.

Although example embodiments have been shown and described in this specification and figures, it would be appreciated by those skilled in the art that changes may be made to the illustrated and/or described example embodiments without departing from their principles and spirit.

What is claimed is:

1. A fuse structure of a semiconductor device, comprising:
a substrate including a fuse region;
an insulation layer pattern having an opening portion that exposes the fuse region, the insulation layer pattern having a multi-layered structure; and
a plurality of fuse lines passing through an inner space of the opening portion and spaced apart from a surface of the fuse region.

2. The fuse structure of claim 1, wherein the plurality of fuse lines horizontally pass through the inner space.

3. The fuse structure of claim 2, wherein
the insulation layer pattern includes an upper insulation layer pattern and a lower insulation layer pattern, and
the plurality of fuse lines are interposed between the upper insulation layer pattern and the lower insulation layer pattern.

4. The fuse structure of claim 1, further comprising:
reinforcement members structurally combined with the plurality of fuse lines to improve structural stability of the plurality of fuse lines.

5. The fuse structure of claim 4, wherein the reinforcement members are second insulation layer patterns covering surfaces of the plurality of fuse lines exposed by the opening portion.

6. The fuse structure of claim 5, wherein the second insulation layer patterns include silicon nitride (SiN).

7. The fuse structure of claim 6, wherein a thickness of the second insulation layer patterns is about 500 \acute{Å} to about 1,000 \acute{Å}.

8. The fuse structure of claim 4, wherein the reinforcement members include vertical patterns to support the plurality of fuse lines.

9. The fuse structure of claim 8, wherein the reinforcement members have one of a fin shape, a cylindrical shape, and a rectangular prism shape.

10. The fuse structure of claim 8, wherein the vertical patterns are arranged in a longitudinal direction of the plurality of fuse lines, and a longitudinal distance between the vertical patterns is shorter than a distance between the plurality of fuse lines.

11. The fuse structure of claim 8, wherein each of the plurality of fuse lines and the vertical patterns for supporting the plurality of fuse lines are one body.

12. The fuse structure of claim 8, wherein
the insulation layer pattern includes an upper insulation layer pattern and a lower insulation layer pattern,
the plurality of fuse lines are interposed between the upper insulation layer pattern and the lower insulation layer pattern, and
lower end portions of the vertical patterns are buried in the lower insulation layer pattern.

13. The fuse structure of claim 12, wherein the reinforcement members include horizontal patterns connected to the lower end portions of the vertical patterns and spaced apart from each other.

14. The fuse structure of claim 13, wherein the lower insulation layer pattern includes,
a first lower insulation layer pattern on the substrate, the horizontal patterns on the first lower insulation layer pattern; and
a second lower insulation layer pattern on the first lower insulation layer pattern, the second lower insulation layer pattern having a recess to define a lower portion of the opening portion.

15. The fuse structure of claim 13, wherein the vertical patterns and the horizontal patterns include a metal.

16. The fuse structure of claim 1, wherein each of the plurality of fuse lines includes an adhesive layer and a metal layer.

17. A method of forming a fuse structure of a semiconductor device, comprising:
forming an insulation layer having a multi-layered structure including a plurality of fuse lines on a substrate including a fuse region; and
forming an insulation layer pattern having an opening portion that exposes the fuse region by partially removing the insulation layer to detach the fuse lines from a surface of the fuse region.

18. The method of claim 17, wherein the plurality of fuse lines are horizontally arranged in the insulation layer.

19. The method of claim 17, further comprising:
forming reinforcement members structurally combined with the fuse lines to improve structural stability of the plurality of fuse lines.

20. The method of claim 19, wherein forming the reinforcement members includes forming second insulation layer patterns to cover surfaces of the plurality of fuse lines exposed through the opening portion.

21. The method of claim 19, wherein forming the insulation layer includes,
forming a lower insulation layer on the substrate;
forming the plurality of the fuse lines on the lower insulation layer; and
forming an upper insulation layer on the lower insulation layer.

22. The method of claim 21, wherein forming the insulation layer pattern includes,
anisotropically etching the upper insulation layer of the fuse region to form a preliminary opening portion exposing a surface of the plurality of fuse lines; and
isotropically etching the lower insulation layer that defines a bottom surface of the preliminary opening portion to form the opening portion to allow the plurality of fuse lines to be spaced apart from the surface of the fuse region.

23. The method of claim 21, wherein forming the lower insulation layer includes,
forming a first lower insulation layer on the substrate; and
forming a second lower insulation layer on the first lower insulation layer.

24. The method of claim 23, wherein forming the reinforcement members includes,
patterning the second lower insulation layer to form a plurality of holes exposing the first lower insulation layer; and
filling the holes with vertical patterns on which the fuse lines are formed.

25. The method of claim 24, wherein the vertical patterns are formed simultaneously during forming a contact plug of the semiconductor device.

26. The method of claim 24, wherein forming the reinforcement members includes forming horizontal patterns, which are exposed through the holes, on the first lower insulation layer.

27. The method of claim 26, wherein the horizontal patterns are formed simultaneously during forming a conductive wiring of the semiconductor device.

28. A fuse structure of a semiconductor device, comprising:
a substrate including a fuse region;
an insulation layer pattern having an opening portion that exposes the fuse region; and
a plurality of fuse lines supported by sidewalls of the insulation layer pattern that define the opening portion, the fuse lines arranged to horizontally pass through an inner space of the opening portion.
